(19) United States
(12) Patent Application Publication
(10) Pub. No.: US 2016/0340506 A1
(43) Pub. Date: Nov. 24, 2016

(54) USE OF SILICONE CONTENT AND FLUOROPOLYMER ADDITIVES TO IMPROVE PROPERTIES OF POLYMERIC COMPOSITIONS

(71) Applicant: Albany International Corp., Rochester, NH (US)

(72) Inventors: Dhruv Agarwal, Cortland, NY (US); Louis Jay Jandris, Lafayette, NY (US)

(21) Appl. No.: 15/157,653

(22) Filed: May 18, 2016

Related U.S. Application Data
(60) Provisional application No. 62/163,164, filed on May 18, 2015.

(51) Int. Cl. C08L 67/02; C08J 3/20; D03D 3/02; D01F 6/84; D03D 9/00; D03D 1/00; C08J 3/00; D21F 1/00

(52) U.S. Cl. CPC C08L 67/02; C08J 3/005; C08J 3/203; D21F 1/0027; D01F 6/84; D03D 9/00; D03D 1/0094; D03D 3/02; C08L 2205/03; C08J 2367/02; C08J 2427/16; C08J 2483/04

(57) ABSTRACT

Described herein are component compositions comprising a blend of a polymer resin together with a fluoropolymer and silicone content additives. In certain embodiments, the components demonstrate improved soil and contaminant resistance as do the industrial fabrics produced that comprise at least one component of the instant invention.

### FIELD OF THE INVENTION

The present invention is directed to endless fabrics, and particularly, industrial fabrics and belts used in the production of paper and its associated processes, and engineered fabrics used in the manufacture of nonwoven products produced by processes such as air laid, melt blown, spun bond, and hydroentangling; belts used in the manufacture of corrugated boxboard; belts used to manufacture building products such as oriented strand board (“OSB”); and belts used in textile finishing processes or hide tanning. More particularly, the invention relates to a polymer resin composition used in the manufacture of components in industrial fabrics and belts made from mixing a polymer resin with fluoropolymer and a silicone content material (for example, siloxane) additives during component extrusion or coating of the industrial fabric to improve cleanability, soil release, and contamination resistance of the industrial fabric or belt.

### BACKGROUND OF THE INVENTION

An industrial fabric or belt is an endless structure in the form of a continuous loop such as a forming fabric, press fabric, dryer fabric or process belt (e.g., shoe press belt, transfer belt, calendar belt), reel belt, a structure used as an impression fabric, through air dryer (“TAD”) fabric used in the production of tissue and towel (together known as “paper machine clothing” or “PMC”). Other industrial fabrics include: corrugator belts for producing corrugated boxboard, fabrics and belts and sleeves used in the production of nonwovens by processes such as melt-blowing, spun bond, hydroentangling, or air laid; a fabric used in a sludge filter or other wet filtration processes; or a fabric used in textile finishing processes such as sanforizing; belts used in hide tanning; and other conveyor belts such as those used in food processing.

While the discussion here is for the papermaking process in general, the application of the present invention is not considered limited thereto.

During the papermaking process, a cellulosic fibrous web is formed by depositing a fibrous slurry, that is, an aqueous dispersion of cellulose fibers, onto a moving forming fabric in a forming section of a paper machine. A large amount of water is drained from the slurry through the forming fabric, leaving the cellulosic fibrous web on the surface of the forming fabric.

The newly formed cellulosic fibrous web proceeds from the forming section to a press section, which includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is directed in a serpentine path sequentially around each in the series of drums by a dryer fabric, which holds the paper sheet closely against the surfaces of the drums. The heated drums reduce the remaining water content of the paper sheet to a desirable level through evaporation.

It should be appreciated that the forming, press and dryer fabrics all take the form of endless loops on the paper machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

In the production of tissue or towel, forming and press fabrics provide the same function as in paper making above. There may also be other fabrics such as impression fabrics or TAD fabrics, as well as reel belts.

Base fabrics, which form an important portion of the above discussed fabrics, take many different forms. For example, they may be woven either endlessly or flat woven and subsequently rendered into endless form with a woven seam using one or more layers of machine direction (“MD”) and cross-machine direction (“CD”) yarns. Further, the woven base fabrics may be laminated by placing one base fabric within the endless loop formed by another, and joining or laminating together by various means known to those skilled in the art such as by needling a staple fiber batt through both base fabrics to join them to one another.

Different polymeric materials may be used in the formation of MD/CD yarns and if present, the batt fibers that form these fabrics. One example of a polymeric resin that may be used for this purpose is polyester. Because these fabrics invariably interact with different cellulosic materials, additives, and dust, it is essential that the material used to form these yarns exhibit good cleanability properties such as soil resistance, desired hydrophobicity, and sheet release capabilities as well as other properties. While pure (100%) material used for a yarn, for example, polyester as a forming fabric yarn, has excellent required yarn modulus, it has relatively poor soil resistance and resistance to contamination. While attempts to improve these shortcomings have been made, none have shown the required level of improvement.

Other structural components, such as foils or films, can be used as a layer in a structure for the uses aforementioned. Such films comprise polymers such as, but not limited to, polyester or polyurethane.

Lastly, coatings such as used to manufacture shoe press belts, calendar belts, transfer belts, certain tissue/towel impression fabrics, and several of the engineered fabrics also have this requirement of anti-contamination or easier removal of contaminants. The coatings may comprise polyurethane or other polymers.

For example, U.S. Pat. Nos. 8,388,812, 8,394,239, 8,728,280, and 8,764,943, pertain to polyester films that are made for use as support members in the production of tissue, towel or nonwoven products.

U.S. Pat. Pub. No. 20120214374 shows a PMC fabric yarn made from polyethylene terephthalate (PET), polymeric siloxane, and a compatibilizer.

U.S. Pat. No. 5,759,685 relates to a process of making a soil-repellent and abrasion-resistant monofilament by polycondensing PET and polydialkyl siloxane and extruding the composition.

U.S. Pat. No. 5,922,463 describes a monofilament made from a PET-polydialkyl siloxane copolymer with specific diameter and strength for improved weavability.

The focus of U.S. Pat. Nos. 5,922,463 and 5,759,685 is on the use of a polycondensation reaction between polydialkyl siloxane and PET to create a silicone-modified PET. Polycondensation limits the flexibility and ease of controlling the final composition of the monofilaments during the extrusion process. U.S. Pat. No. 5,759,685 does briefly mention the possibility of using a pure PET resin and adding polydimethyl siloxane upstream of the extruder via a metering device; however, when put into practice this led to processing issues due to phase separation of the two materials.

U.S. Pat. Pub. No. 20100068516 incorporates a fluoropolymer into a PET melt to form fibers with increased wear resistance.

U.S. Pat. No. 5,489,467 pertains to a woven fabric of polyester monofilaments manufactured from a polymer blend of polyester resin, a melt extrudable fluoropolymer resin, and a hydrolytic stabilizing agent for utility as fabrics in drying processes of paper making machines.

Int'l Pat. Appn. No. WO2012/140993 describes a two-layer weave for a fabric made from a fluororesin to prevent adhesion of fibers and to maintain antifouling properties.

U.S. Pat. No. 6,136,437 relates to yarn that is made from a fluoropolymer and an aromatic dicarboxylic acid polymer for use in industrial and papermaker's fabric.

U.S. Pat. Pub. No. 20070232170 pertains to a blend of polyester resin and fluoropolymer resin with compatabilized side groups, such as maleic anhydride for use in yarns for papermaking fabrics.

U.S. Pat. No. 5,283,110 describes a high temperature copolyester monofilament with enhanced knot tenacity formed by extruding a copolyester resin together with a fluoropolymer resin. Thermal stabilizer and hydrolytic stabilizer additives are also described.

U.S. Pat. No. 5,378,537 relates to a polyester monofilament containing carbodiimide, and a fluorine type polymer.

U.S. Pat. No. 5,297,590 pertains to a fabric for use in paper forming machines that is made of MD and CD monofilaments consisting of PET and fluorocarbon polymers.

Finally, U.S. Pat. No. 7,306,703 describes coating polyester resin structures with fluoropolymers.

When a fabric structure is used as paper machine clothing, contaminants adhere to the surfaces of the various fabric components during processing. These contaminants include fibers (cellulosic or other) and other adhesive materials (e.g., low melting point materials, glues, lignin, pitch, etc.—together known as “stickies”). A fabric demonstrating good cleanability and soil release properties is therefore needed.

### SUMMARY OF THE. INVENTION

An object of this invention is to create a polymeric composition used to form a component in an industrial fabric, that reduces the accumulation of contaminants on the component and within the industrial fabric, and to make it easier to remove contaminants through a cleaning regimen (e.g., showers, suction boxes, detergents, etc.).

“Components” include fibers, filament yarns, films, foils, tapes, netting (mesh), rings, spiral link coils or other extruded components, a structured polymer resin deposit in a desired pattern, or a coating (either the deposit or coating can be continuous on a surface, or discontinuous in a desired pattern for example, rectangles), or side by side continuous or discontinuous MD or CD strips wherein the edges of the adjacent strips are not in contact with each other, i.e., there is a “space” in between adjacent strips).

In certain embodiments, an advantage of the present invention is to improve the ease of “sheet release” of a paper, tissue/towel, or nonwoven product produced using a fabric, belt or sleeve of the instant invention. The improved sheet release is thought to be due to: a change in hydrophobicity, hydrophilicity, surface tension, surface charge, a lowered coefficient of friction, adhesive forces, or a combination of two or more of these characteristics of the fabric, belt, or sleeve because of surface property changes in the component material due to introduction of a fluoropolymer and a silicone additive together in the component resin material.

In other embodiments, another advantage of the present invention is that use of the polymer-fluoropolymer-silicone content mixture to extrude a monofilament yarn to make spiral coils leads to easier coiling and assembly of the coils into a spiral link belt structure.

It is an object of the present invention to provide a polymeric component composition comprising a polymer resin, a fluoropolymer additive, and a silicone content (for example, a siloxane) additive, which is suitable for the production of fibers, filaments, films, foils, tapes, netting (mesh), rings or other extruded components, a structured deposit in a desired pattern, or a coating exhibiting improved cleanability, soil resistance, reduced coefficient of friction, desired hydrophobic, hydrophilic, oleophobic properties, higher water contact angle, and improved sheet release properties compared to components of pure 100% polymer resin or other combinations of resin and additives.

It is another object of the present invention to provide an industrial fabric or belt with improved cleanability properties such as soil resistance, sheet release, and relative hydrophobicity/hydrophilicity/oleophobicity where that fabric or belt is produced using a component comprising a polyester resin, such as for example: polyethylene terephthalate (PET), polyethylene naphthalate (PEN), polybutylene terephthalate (PBT), polybutylene naphthalate (PBN), polytrimethylene naphthalate (PTN), poly(cyclohexylene dimethylene terephthalate) acid (PCTA), aromatic, copolymers or blends of polyester; or a polyamide, such as, for example PA 6; PA 6,6; PA 6,12; PA 6,10; PA 4,6; PA 10; PA 11; PA 12; or MXD6; aromatic, copolymers or blends of polyamides; polyphenyl sulfide (PPS) or blends thereof; polyether ether ketone (PEEK) or blends thereof; polyether ketone (PEK) or blends thereof; or polyurethane or blends thereof “Blends thereof” as used herein shall mean that the resin named can be blended with another resin such as a polyester can be blended with a polyurethane, or two polyesters or two polyamides can be blended together.

The polymer composition according to the present invention is suitable for the production of components such as fibers and filament yarns. More specifically, the polymer resin composition is suitable for manufacturing of yarns, fibers, films, foils, tapes, netting (mesh), rings or other extruded components, a structured deposit in a desired pattern, or a coating made from a blend of polymer resin, fluoropolymer and silicone content (e.g., siloxane) additives, and optionally other additives that can be used in industrial fabrics, and a method of manufacturing the same.

In certain embodiments, a resin composition suitable for the production of the aforementioned components exhibiting the above discussed properties is obtained by blending a fluoropolymer and a silicone additive with a mixture of a polyester resin.

In additional embodiments, the water contact angle of a polyester monofilament yarn composition comprising the fluoropolymer and a silicone content material is greater than about 74 degrees.

In a particular embodiment, a resin component composition of the invention is produced by extruding 100 parts by weight of a mixture comprising about 50 to about 98% by weight of a polyester resin, such as PET, with an intrinsic viscosity of about 1.2 dL/g; about 0.5 to about 15% by weight of a fluoropolymer, such as PVDF; about 0.5 to about 15% by weight of a siloxane, such as PDMS; about 0.5 to about 15% by weight of a stabilizer, such as a carbodiimide (e.g., Stabaxol® 1LF, PX-100, or PX-200); and about 0.2 to about 5% by weight of a coloring agent. Optionally, hydrolytic stabilizers, filters, silica (fumed or fused), tensile modifiers, or other additives may be used. In embodiments where the resin component composition is used to produce a monofilament yarn, the monofilament yarn composition is typically suitable for all yarn types used in the aforementioned industrial fabrics.

In another embodiment, a resin component composition of the invention is produced by extruding 100 parts by weight of a mixture comprising about 80 to about 97% by weight of a polyester resin, such as PET, with an intrinsic viscosity of between about 0.7 dL/g to about 0.75 dL/g or about 0.85 dL/g to about 1.0 dL/g; about 1 to about 6% by weight of a fluoropolymer, such as PVDF; about 1 to about 6% by weight of a siloxane, such as PDMS; about 1 to about 3% by weight of a stabilizer, such as a carbodiimide (e.g., Stabaxol® 1LF, PX 100, or PX-200); and about 0.4 to about 3% by weight of a coloring agent. Optionally, hydrolytic stabilizers, fillers, silica (fumed or fused), tensile modifiers, or other additives may be used. In embodiments where the resin component composition is used to produce a monofilament yarn, the monofilament yarn composition is typically suitable for all yarn types used in the aforementioned industrial fabrics.

In further embodiments, a resin component composition of the invention is produced by extruding 100 parts by weight of a mixture comprising 94.25 to 95.85% by weight of a polyester resin, such as PET; 2,5% by weight of a fluoropolymer, such as PVDF; 1.25% by weight of a siloxane, such as PDMS; 1.25% by weight of a stabilizer, such as a carbodiimide; and 0.4 to 2% by weight of a coloring agent. In embodiments where the resin component composition is used to produce a monofilament yarn, the monofilament yarn composition is typically suitable for all yarn types used in the aforementioned industrial fabrics.

As described herein, the instant invention pertains to a resin component composition comprising a polymer resin, a fluoropolymer additive, and a silicone content additive. In some embodiments, about 50% to about 98% of said composition by weight comprises a polymer resin. In some embodiments, about 80% to about 97% of the composition by weight comprises a polymer resin.

In some embodiments, about 0.5% to about 15% of said composition by weight comprises a fluoropolymer additive. In certain embodiments, about 1% to about 6% of said composition by weight comprises a fluoropolymer additive.

In some embodiments, about 0.5% to about 15% of said composition by weight comprises a silicone content additive. In certain embodiments, about 1% to about 6% of said composition by weight comprises a silicone content additive.

In certain embodiments, about 50% to about 98% of the composition by weight comprises a polymer resin, about 0.5% to about 15% of the composition by weight comprises a fluoropolymer additive, and about 0.5% to about 15% of the composition by weight comprises a silicone content additive. In other embodiments, about 80% to about 97% of the composition by weight comprises a polymer resin, about 1% to about 6% of the composition by weight comprises a fluoropolymer additive, and about 1% to about 6% of the composition by weight comprises a silicone content additive.

In certain embodiments, the polymer resin comprises at least one polyester selected from the group consisting of: polyethylene naphthalate (PEN), polyethylene terephthalate (PET), polybutylene naphthalate (PBN), polytrimethylene naphthalate (PTN), poly(cyclohexylene dimethylene terephthalate) acid (PCTA), and polybutylene terephthalate (PBT). In certain embodiments, the polyester resin has an intrinsic viscosity of about 1.2 dL/g. In other embodiments, the polyester resin has an intrinsic viscosity of between about 0.7 and 0.75 dL/g. In yet other embodiments, the polyester resin has an intrinsic viscosity of between about 0.85 to 1.0 dL/g.

In certain embodiments, the fluoropolymer additive comprises at least one fluoropolymer selected from the group consisting of: polytetrafluoroethylene (PTFE), polyvinylidene fluoride (PVDF), ethylene tetrafluoroethylene (ETFE), perfluorinated polyether (PFPE), and a modified fluoroalkoxy (MFA) polymer.

In certain embodiments, the silicone additive comprises a siloxane. In further embodiments, the silicone additive is selected from the group consisting of: polydimethylsiloxane (PDMS), PDMS derivatives, polydiphenylsiloxane, cyclic siloxane, and aminoalkyl siloxane.

In some embodiments, the composition comprises fumed silica.

In yet other embodiments, the composition comprises a polymer selected from the group consisting of polyamide (PA 6; PA 6,6; PA 6,12; PA 6,10; PA 4,6: PA 10; PA 11: PA 12, and aromatic derivatives thereof), polyether ether ketone (PEEK), polyether ketone (PEK) and poly(p-phenylene sulfide) (PPS/Ryton®), or polyurethane.

In a particular embodiment, the composition comprises a polyester resin, which comprises PET and a fluoropolymer additive, which comprises PVDF. In further embodiments, the silicone additive comprises a siloxane. In certain embodiments, the silicone additive is selected from the group consisting of polydimethylsiloxane (PDMS), PDMS derivatives, polydiphenylsiloxane, cyclic siloxane, and aminoalkyl siloxane.

In a particular embodiment, the polymer resin of the composition is PET, the fluoropolymer additive is PVDF, and the silicone content additive is PDMS.

In certain embodiments, the composition comprises (a) 94.25% to 95.85% by weight PET; (b) 2.5% by weight PVIV; (c) 1.25% by weight PDMS; (d) 1.25% by weight carbodiimide; (e) 0.4% to 2% by weight of a coloring agent; and (f) 0.10% to 5.0% by weight fumed silica.

In some embodiments, the composition comprises one or more additives selected from the group consisting of: stabilizers, compatibilizers, hydrolysis or oxidation-resistant additives, dyes, pigments, and fumed silica.

In some embodiments, the composition is used to make a monofilament wherein the water contact angle measured on the yarn surface is greater than 74 degrees.

In other embodiments, the composition is used to manufacture a monofilament yarn, wherein the monofilament yarn has a round or nonround cross-section.

In yet other embodiments, the instant invention pertains to a method of manufacturing a resin component composition comprising a polymer resin, a fluoropolymer additive, and a silicone content additive wherein said fluoropolymer additive and said silicone content additive are added to said polymer resin, which is then extruded. In some embodiments, the composition comprises one or more polymers selected from the group consisting of: polyamide (PA 6, PA 6,6, PA 6,12, PA 6,10, PA 4,6, PA 10, PA 11, PA 12, and aromatic derivatives thereof), polyether ether ketone (PEEK), polyether ketone (PEK), poly(p-phenylene sulfide) (PPS/Ryton®), and polyurethane. In other embodiments, the composition comprises one or more polymers selected from the group consisting of polyethylene naphthalate (PEN), polyethylene terephthalate (PET), polybutylene naphthalate (PBN), polytrimethylene naphthalate (PTN), poly(cyclohexylene dimethylene terephthalate) acid (PCTA), and polybutylene terephthalate (PBT).

In some embodiments, the composition manufactured by the method comprises one or more additives selected from the group consisting of: stabilizers, compatibilizers, hydrolysis or oxidation-resistant additives, dyes, pigments, and fumed silica.

In some embodiments, the composition manufactured by the method is extruded into fiber, yarn, rings, films, foil, mesh, netting, or other extruded elements, a structured deposit in a desired pattern, or a coating. In further embodiments, the extruded fiber has a size between about 1.1 dtex to about 200 dtex. In certain embodiments, the extruded yarn has a diameter between about 0.08 mm to about 5 mm.

In some embodiments, the composition manufactured by the method is used to manufacture a component of an industrial fabric, wherein said component is a yarn, fiber, film, foil, tape, netting (mesh), rings or other extruded elements, a structured deposit in a desired pattern, or a coating. In certain embodiments, the industrial fabric comprises a fabric selected from the group consisting of PMC forming, press, and dryer fabrics, as well as process belts, impression fabrics; TAD fabrics; fabrics for eTAD, ATMOS, or NTT machines; engineered fabrics, sleeves or belts used in the production of nonwoven fabrics by processes such as air laid, melt blowing, spunbonding or hydroentangling; fabrics used in a sludge filter or other wet filtration process; conveyor belts for industrial uses such as food processing or mining; corrugator belts; spiral coil links for spiral link belts, their pintles or any stuffer yarns; fabrics or belts used in textile finishing processes; belts or fabrics used to produce building products; or tannery belts or sleeves. In some embodiments, the industrial fabric is woven from yarns in the MD and/or CD, or is a nonwoven fabric layer of MD or CD yarn arrays, spiral links, mesh or netting, rings, foils, films or other extruded elements, a structured deposit in a desired pattern, or a coating.

In yet other embodiments, the instant invention relates to a mesh or netting, fiber, yarn, rings, films, foil, or other extruded elements, a structured deposit in a desired pattern, or a coating, comprising a resin component composition comprising a polymer resin, a fluoropolymer additive, and a silicone content additive.

In still other embodiments, the instant invention pertains to a paper machine clothing, comprising a resin component composition comprising a polymer resin, a fluoropolymer additive, and a silicone content additive. In certain embodiments, the paper machine clothing is selected from the group consisting of: a reel belt, a TAD, an eTAD, an ATMOS, and an NTT fabric. In further embodiments, the component is a batt portion of a press fabric or a corrugator belt.

In other embodiments, the instant invention relates to an industrial fabric, belt, or sleeve comprising a resin component composition comprising a polymer resin, a fluoropolymer additive, and a silicone content additive.

In certain embodiments, the resin component composition of the instant invention is used to produce fiber, wherein said fiber is used in the batt portion of industrial fabric.

In some embodiments, the instant invention pertains to an engineered fabric comprising a DNT belt, a belt for a filter press, pulp washer, belt to produce building products such as oriented strand board or a corrugators belt, a tannery sleeve, or a textile finishing belt, comprising a resin component composition comprising a polymer resin, a fluoropolymer additive, and a silicone content additive. In further embodiments, the component is a batt portion of a press fabric or a corrugator belt. In certain embodiments, the fabric, sleeve, or belt is used to produce nonwovens by a process selected from the group consisting of: air laid, spun bond, melt spun, or hydroentangling.

In other embodiments, the instant invention relates to a stuffer yarn or pintle comprising a resin component composition comprising a polymer resin, a fluoropolymer additive, and a silicone content additive.

Terms “comprising” and “comprises” in this disclosure can mean “including” and “includes” or can have the meaning commonly given to the term “comprising” or “comprises” in U.S. Patent Law. Terms “consisting essentially of” or “consists essentially of” if used in the claims have the meaning ascribed to them in U.S. Patent Law. Other aspects of the invention are described in or are obvious from (and within the ambit of the invention) the following disclosure.

### BRIEF DESCRIPTION OF THE DRAWINGS

The accompanying drawings, which are included to provide a further understanding of the invention, are incorporated in and constitute a part of this specification,

FIG. 1 is a graph comparing the water contact angle of a pure PET monofilament with that of a PET-fluoropolymer, a PET-silicone content material, and a monofilament yarn composition according to one embodiment of the invention.

FIG. 2 depicts fabrics comprising polyester yarns that are made with and without a silicone content material and a fluoropolymer together before and after use on a paper machine.

### DETAILED DESCRIPTION OF THE INVENTION

The present invention combines two or more materials with desired favorable properties to a polymer resin in a synergistic manner, such that the properties (for example, tensile modulus) of the component comprising the resin are maintained and such that the combination of the additive materials offers a synergistic effect on the component's anti-soiling or soil release properties as well as easier cleanability. The synergistic effect seen by combining these two additives in a polymer resin is a surprising and unexpected result of the instant invention when the component is present, for example, in an industrial fabric.

In the industrial fabric and belts aforementioned, the inventive polymeric material can be used to make extruded yarns for a woven structure. MD or CD yarn arrays, or to make the yarn used to manufacture spiral coil links (see, for example, U.S. Pat. No. 4,567,077); to make a mesh or netting (see, for example, Johnson et al., U.S. Pat. No. 4,427,734); to make rings (see, for example, Hansen et al., U.S. Pat. No. 6,918,998); or other extruded elements (see, for example, Hansen et al., U.S. Pat. No. 6,630,223); films or foils such as taught in U.S. Pat. Nos. 8,388,812; 8,728,280; 8,764,943; and U.S. Pat. No. 8,394,239; to make fiber for use in structures such as the batt portion of a press fabric or a corrugator belt; to make a controlled polymer resin structured deposition on the surface of a belt or fabric; or to coat one or both surfaces of a belt or sleeve (e.g., sheet contact surface or machinery contact surface).

The component can be used in structures such as: PMC (forming fabrics, press fabrics, dryer fabrics, shoe press belts, or transfer belts), reel belts, TAD fabrics, impression fabrics, Energy Efficient Technologically Advanced Drying (“eTAD”) fabrics, Advanced Tissue Molding Systems (“ATMOS”) fabrics or belts, New Tissue Technology (“NTT”) fabrics or belts, double nip thickeners (“DNT”) fabrics, belt filters, pulp washers, belts/fabrics/sleeves for the production of nonwovens (for example, airlaid, spunbond, melt spun, hydroentangled), belts to produce building products (for example, oriented strand board (“OSB”)), corrugator belts, textile finishing belts (for example, sanforizing belts), and tannery belts or sleeves.

In certain, embodiments, the present invention improves soil resistance and sheet release properties, for example, of yarns or fibers by blending a polymer with fluoropolymer and silicone content (for example, siloxane) additives during or before the extrusion, deposition or coating process. It is commonly known in the art that fluoropolymers have adhesion resistance properties (release) and silicone content materials have water absorption or surface resistance (hydrophobicity) properties. But the inventors have discovered a synergistic effect of these additives on polymer resins such as polyester with industrial fabric applications such as a component in paper machine clothing. Because of the need for soil resistant, low coefficient of friction, water resistant, more easily cleanable materials in industrial fabric applications, one aspect of the present invention is the production of monofilaments made from a polymer, such as a polyester resin, with fluoropolymer and silicone content additives for use in yarns for industrial fabrics.

In certain embodiments, the present invention relates to a multicomponent yarn or fiber having excellent cleanability properties such as soil resistance, appropriate hydrophobicity, lower coefficient of friction, and improved sheet release ability, which comprises, as main components, a polymer, such as a polyester resin, a fluoropolymer additive, and a silicone additive, combined to produce a monofilament yarn composition. The present invention further relates to filaments, films, foils, tapes, netting (mesh), rings, spiral link coils or other extruded components, a structured deposit in a desired pattern, or a coating (either the deposit or coating be continuous on a surface, or discontinuous in a desired pattern (for example, rectangles), or side by side continuous or discontinuous MD or CD strips wherein the edges of the adjacent strips are not in contact with each other; e.g., there is a “space” in between adjacent strips); produced by using this polymer resin composition.

In some embodiments, it is thought that the presence of the silicone content additive acts as a friction modifier that essentially retards the tribocharging of a belt produced with yarns of the instant invention. The silicone content additive does not make the belt more conductive, but rather it affects the ability of the belt to generate static charge when in operation.

In some embodiments, the present invention involves combining at the same time a silicone content additive and a fluoropolymer additive with one or more polymeric materials, all of which is then extruded. There may be additional additives in the mixture, such as stabilizers, compatibilizers, hydrolysis or oxidation-resistant additives, dyes, and/or pigments. The polymeric material mixture is then extruded into fiber, yarn, rings, films, foils, mesh, netting, or other forms. The inventive material composition can also be used as a structured deposit or as a coating (either the deposit or coating can be continuous on a surface, or discontinuous in a desired pattern (for example, rectangles), or side by side continuous or discontinuous MD or CD strips wherein the edges of the adjacent strips are not in contact with each other; e.g., there is a “space” in between adjacent strips) as a component of an industrial fabric or belt.

For example, the industrial fabric may be a corrugator belt used on a machine producing corrugated boxboard. The surface of the belt, which can be a woven structure, a woven structure with needled in batt fiber on the sheet and/or machine contact sides, or a spiral link structure, which has deposited on the sheet contact surface a plurality of MD strips of the inventive resin composition. The strips can be in the MD, at an angle to the MD, or in the CD. The adjacent strip edges are not contacting each other but there is a space to allow air and water vapor permeability through the belt.

The industrial fabric may also be a transfer belt. It is important that such belts exhibit excellent controlled sheet release and that the surfaces remain contaminant free. Transfer belts are coated on both sides to achieve these properties. The coating can be applied separately to both sides, or from one side and allowed to impregnate the structure, or a combination of both. The machinery contact side should typically have sufficient roughness to prevent hydroplaning, and therefore not exhibit instability or poor guiding. The roughness can be achieved by grooving, for example. In a particular embodiment, polyurethane is the preferred coating resin, and its properties can be improved utilizing the intended composition comprising urethane, fluoropolymer and a silicone content material in the coating.

Fabric fibers have different degrees of coarseness, which is measured in terms of linear mass density, or decitex (“dtex”). In some embodiments, a fiber of the instant invention is between about 0.5 dtex to about 240 dtex in coarseness.

In some embodiments, the round cross-section monofilament yarns of the invention have a diameter between 0.06 mm to 5.0 mm. The subject yarn may have a non-round cross-section (e.g., square, rectangular, oval, ovate, rhombic, triangular, etc.) of suitable dimensions known to those of ordinary skill in the art for the intended use.

The inventive combination of the fluoropolymer and a silicone content (for example, siloxane) additives may be mixed with any suitable polymer, such as one or more polyesters (e.g., PET, PBT, PEN, PCTA, etc.), polyamides (e.g., PA 6; PA 6,6; PA 6,12; PA 6,10; PA 4,6; PA 10; PA 11; PA 12 or polyaramid derivatives like Nomex®), polyether ether ketone (PEEK), polyether ketone (PEK), or poly(p-phenylene sulfide) (PPS or Ryton®).

The polymer composition may then be used in industrial fabrics structures such as PMC (forming fabrics, press fabrics, dryer fabrics, shoe press belts, or transfer belts), reel belts, TAD fabrics, impression fabrics, eTAD fabrics, and ATMOS fabrics; and engineered fabrics, such as double nip thickeners (“DNT”) fabrics, belt filters, pulp washers, belts/fabrics/sleeves for the production of nonwovens (for example, airlaid, spunbond, melt spun, hydroentangled), belts to produce building products (for example, oriented strand board (OSB), corrugator belts, textile finishing belts (for example, sanforizing belts), and tannery belts or sleeves).

The present invention, according to one embodiment, is a component comprising a blend of (1) a polyester selected from a group including but not limited to, e.g., polyethylene naphthalate (PEN), polyethylene terephthalate (PET), polybutylene naphthalate (PBN), polytrimethylene naphthalate (PTN), polybutylene terephthalate (PBT), poly(cyclohexylene dimethylene terephthalate) acid (PCTA), aromatic, copolymers and blends of polyester; (2) a fluoropolymer selected from a group including but not limited to, e.g., polytetrafluoroethylene (PTFE), polyvinylidene fluoride (PVDF), ethylene tetrafluoroethylene (ETFE), perfluorinated polyether (PFPE), or a modified fluoroalkoxy (MFA) polymer; and (3) a silicone content material such as a siloxane, e.g., polydimethylsiloxane (PDMS), PDMS derivatives, polydiphenylsiloxane, cyclic siloxane, and aminoalkyl siloxane. The resin component composition optionally contains other additives and ingredients.

As a monofilament disclosed herein, it may be used as warp and/or weft yarns in the production of industrial fabrics such as paper machine clothing and engineered fabrics aforementioned. As a filament, it may also be further processed and cut into fiber used in the batt material that may be attached to the base structure of some of these fabrics. In certain embodiments, the mixture of polyester, fluoropolymer, and silicone content material (for example siloxane) provides the monofilament or fiber with lower coefficient of friction, improved soil resistance, and increased hydrophobicity. The above disclosed composition can also be used to produce any of the other aforementioned components according to one embodiment of the invention.

In certain embodiments, the addition of a silicone content material and fluoropolymer additives to polyester (e.g., PET) monofilaments increases the water contact angle of the monofilament and improves its soil resistance.

In further embodiments, in the manufacturing process to make spiral coils, it also significantly improves the spiraling process in manufacturing, for example, coil formation and assembly when a silicone content material and a fluoropolymer are synergistically used as additives in polyester (e.g., PET) monofilaments used to make the spiral coils. Furthermore, in some spiral link belts, “stuffer yarns” are used to control the belt air permeability and air flow. The inventive composition can be used to make these stuffer yarns as well.

In embodiments of the inventive composition where the polyester is PET, water contact angle testing of PET tapes and monofilaments has shown that the addition of a silicone content additive (e.g., siloxane) and fluoropolymer to the PET during the extrusion process results in a higher water contact angle (75 degrees) when compared to a 100% (of the same PET) monofilament (62 degrees). Typically, the water contact angle of an inventive monofilament yarn composition as described herein is greater than about 74 degrees. In particular embodiments, the combination of silicone content additive (e.g., siloxane) and fluoropolymer additive works in two ways: (1) it increases hydrophobicity and (2) it improves oil and soil resistance. A higher water contact angle on PET monofilaments of the invention indicates improved cleanability of paper machine clothing comprising the inventive monofilaments during use on a paper or tissue/towel machine.

In one embodiment, a silicone content material is pre-compounded by a compounder to make a masterbatch. In some embodiments, the masterbatch is 30% silicone content material and 70% PET. In certain embodiments, about 4-7% by weight of the total composition used to extrude a monofilament yarn is the masterbatch.

In some embodiments, the overall percentage of the silicone content material in the monofilament is about 1-4%, and the fluoropolymer additive (e.g., PVDF) overall percentage content in the monofilament is about 1-5%. Other additives such as fumed silica may be present in amounts from about 0.10 to 5.0%.

Fluoropolymers when used in components in yarns used in PMC have been shown to be contaminant resistant, especially toward contaminants such as starches and “stickies.” At the same time, the presence of siloxane (or other silicone content compound) in the compositions of the instant invention imparts desired hydrophobicity, which affects surface tension as well as water absorption. The combination of both of these materials creates a set of unique characteristics to the monofilament, such that both of the materials (fluoropolymer and silicone content additive) help to keep the fabric cleaner and free of contaminant buildup. If the fabric comprising the inventive yarns does see some contaminant buildup, and receives a “shower cleaning,” for example, the inventive yarns will enable better and more efficient fabric cleaning. Because the fluoropolymer resists materials from strongly adhering to the yarn surface, for example, and, further, the silicone content material imparts a more rapid water-shedding ability, accordingly, in certain embodiments, showering the fabric with water will remove the stickies and other contaminants quickly and effectively.

The polymer resin-fluoropolymer-silicone content material composition according to the present invention is also suitable for the production of all the other aforementioned components. The polymer resin-fluoropolymer-silicone content material composition is suitable for manufacturing any of the components that can be used in the manufacture of PMC engineered fabrics used in a sludge filter or other wet filtration process; base support structures for industrial process belts, such as conveyor belts for industrial uses such as food processing or mining; corrugator belts; spiral coil links for spiral link belts, their pintles or any stuffer yams; or fabrics used in textile finishing processes, and a method of manufacturing the same. Any of the above structures comprising yarns can be woven or not woven, including spiral coil link structures as well as MD/CD yarn arrays. Further, the monofilament yarn compositions may be used as sniffers and pintles for both spiral link fabrics (sniffers) and all seams (e.g., pin seams, spiral seams, etc.).

The present invention will now be further described by way of the following ion-limiting Examples:

### Example 1

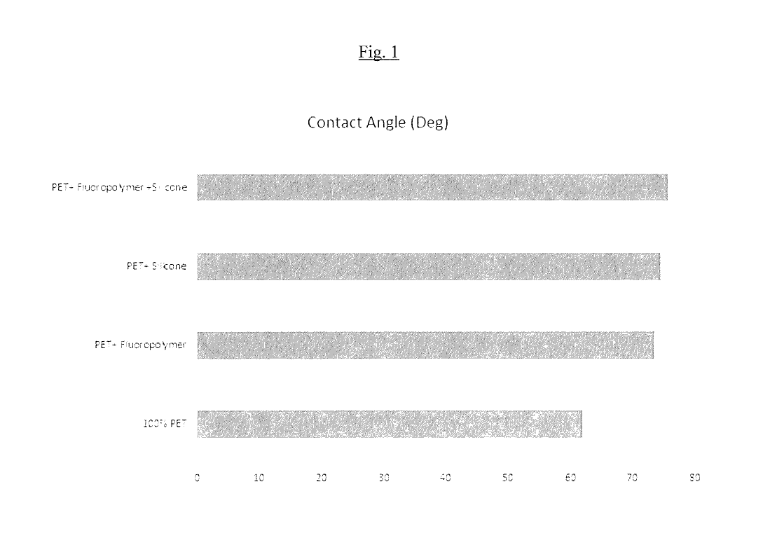

FIG. 1 is a graph comparing the water contact angle of a pure PET monofilament with that of a PET-fluoropolymer, a PET-silicone content material, and a monofilament yarn composition according to one embodiment of the invention.

### Example 2

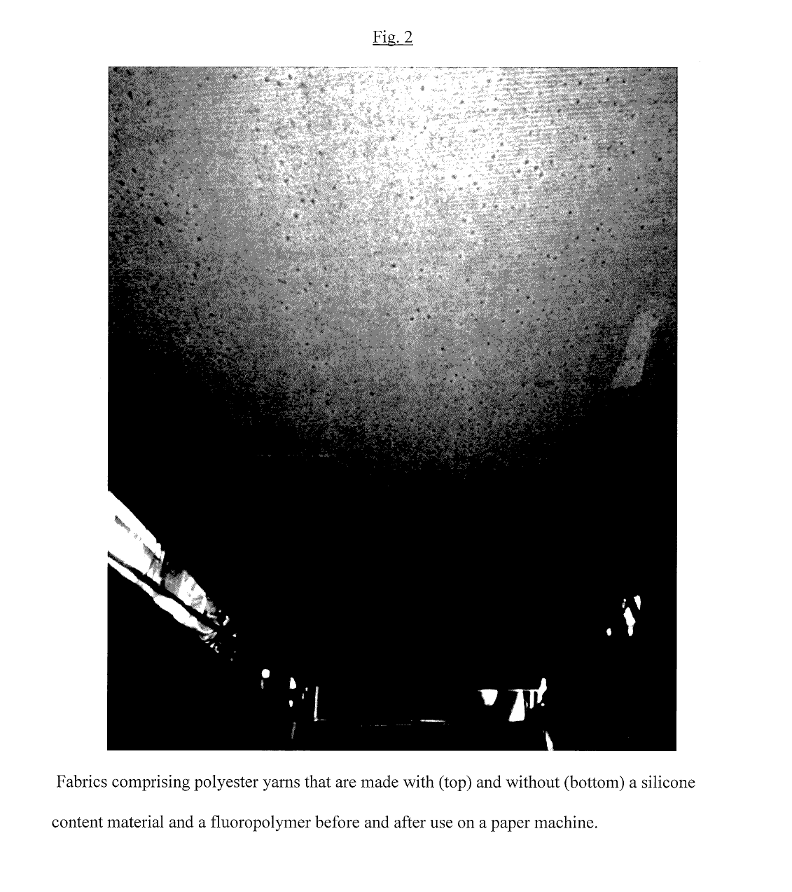

FIG. 2 depicts fabrics that comprise yarns that are made with and without a silicone content material and fluoropolymer before and after use on a paper machine.

Top: Fabric containing fluoropolymer and silicone content material yarns.

Bottom: Fabric not containing fluoropolymer and silicone content material yarns.

The fabrics were used on a paper machine for 40 days. The top fabric, comprising yarns containing a fluoropolymer and a silicone content material, is visibly cleaner than the fabric comprising yarns without a fluoropolymer and a silicone content material. The black specks are the unwanted deposits.

While specific embodiments of the subject invention have been discussed, the above specification is illustrative and not restrictive. One of ordinary skill in the art will appreciate that numerous changes and modifications can be made to the invention, and that such changes and modifications can be made without departing from the spirit and scope of the invention. The full scope of the invention should be determined by reference to the claims, along with their full scope of equivalents, and the specification, along with such variations.

Likewise, although technical features of the present invention might have been described only with respect to certain embodiments, the ordinarily skilled artisan will understand that features of some embodiments may be combined with features of other embodiments and that specific combinations of features described with respect to certain embodiments may also be combined with other features or other specific combinations of features described with respect to other embodiments.

Each patent, patent application, and publication cited or described in the present application is hereby incorporated by reference in its entirety as if each individual patent, patent application, or publication was specifically and individually indicated to be incorporated by reference.

What is claimed is:

1. A resin component composition comprising:
a polymer resin;
a fluoropolymer additive; and
a silicone content additive.

2. The composition according to claim 1, wherein about 50% to about 98% of said composition by weight comprises a polymer resin.

3. The composition according to claim 1, wherein about 0.5% to about 15% of said composition by weight comprises a fluoropolymer additive.

4. The composition according to claim 1, wherein about 0.5% to about 15% of said composition by weight comprises a silicone content additive.

5. The composition according to claim 1, wherein about 50% to about 98% of said composition by weight comprises a polymer resin, about 0.5% to about 15% of said composition by weight comprises a fluoropolymer additive, and about 0.5% to about 15% of said composition by weight comprises a silicone content additive.

6. The composition according to claim 1, wherein said polymer resin comprises at least one polyester selected from the group consisting of: polyethylene naphthalate (PEN), polyethylene terephthalate (PET), polybutylene naphthalate (PBN), polytrimethylene naphthalate (PTN), poly(cyclohexylene dimethylene terephthalate) acid (PCTA), and polybutylene terephthalate (PBT).

7. The composition according to claim 1, wherein said fluoropolymer additive comprises at least one fluoropolymer selected from the group consisting of: polytetrafluoroethylene (PTFE), polyvinylidene fluoride (PVDF), ethylene tetrafluoroethylene (ETFE), perfluorinated polyether (PFPE), and a modified fluoroalkoxy (MFA) polymer.

8. The composition according to claim 1, wherein said silicone additive comprises a siloxane.

9. The composition of claim 8, wherein the silicone additive is selected from the group consisting of: polydimethylsiloxane (PDMS), PDMS derivatives, polydiphenylsiloxane, cyclic siloxane, and aminoalkyl siloxane.

10. The composition according to claim 1, wherein said composition comprises fumed silica.

11. The composition according to claim 1, wherein said composition comprises a polymer selected from the group consisting of polyamide (PA 6; PA 6,6; PA 6,12; PA 6,10; PA 4,6; PA 10; PA 11; PA 12, and aromatic derivatives thereof), polyether ether ketone (PEEK), polyether ketone (PEK) and poly(p-phenylene sulfide) (PPS/Ryton®), or polyurethane.

12. The composition according to claim 6, wherein said polyester resin comprises PET and said fluoropolymer additive comprises PVDF.

13. The composition according to claim 12, wherein said silicone additive comprises a siloxane.

14. The composition according to claim 13, wherein the silicone additive is selected from the group consisting of polydimethylsiloxane (PDMS), PDMS derivatives, polydiphenylsiloxane, cyclic siloxane, and aminoalkyl siloxane.

15. The composition according to claim 2, wherein about 80% to about 97% of said composition by weight comprises a polymer resin.

16. The composition according to claim 3, wherein about 1% to about 6% of said composition by weight comprises a fluoropolymer additive.

17. The composition according to claim 4, wherein about 1% to about 6% of said composition by weight comprises a silicone content additive.

18. The composition according to claim 5, wherein about 80% to about 97% of said composition by weight comprises a polymer resin, about 1% to about 6% of said composition by weight comprises a fluoropolymer additive, and about 1% to about 6% of said composition by weight comprises a silicone content additive.

19. The composition according to claim 5 or 18, wherein said polymer resin is PET, said fluoropolymer additive is PVDF, and said silicone content additive is PDMS.

20. The composition according to claim 6, wherein said polyester resin has an intrinsic viscosity of about 1.2 dL/g.

21. The composition according to claim 6, wherein said polyester resin has an intrinsic viscosity of between about 0.7 and 0.75 dL/g.

22. The composition according to claim 6, wherein said polyester resin has an intrinsic viscosity of between about 0.85 to 1.0 dL/g.

23. The composition according to claim 19, wherein:
(a) 94.25% to 95.85% of said composition by weight is PET;
(b) 2.5% of said composition by weight is PVDF;
(c) 1.25% of said composition by weight is PDMS;
(d) 1.25% of said composition by weight is carbodiimide;
(e) 0.4% to 2% of said composition by weight is a coloring agent; and
(f) 0.10% to 5.0% of said composition by weight is fumed silica.

24. The composition according to claim 1, wherein said composition comprises one or more additives selected from the group consisting of stabilizers, compatibilizers, hydrolysis or oxidation-resistant additives, dyes, pigments, and fumed silica.

25. The composition according to claim 1, used to make a monofilament wherein the water contact angle measured on the yarn surface is greater than 74 degrees.

26. The composition according to claim 1, used to manufacture a monofilament yarn, wherein the monofilament yarn has a round or nonround cross-section.

27. A method of manufacturing a resin component composition comprising a polymer resin, a fluoropolymer additive, and a silicone content additive wherein said fluoropolymer additive and said silicone content additive are added to said polymer resin, which is then extruded.

28. A method of manufacturing the composition according to claim 27, wherein said composition comprises one or more polymers selected from the group consisting of polyamide (PA 6, PA 6,6, PA 6,12, PA 6,10, PA 4,6, PA 10, PA 11, PA 12, and aromatic derivatives thereof), polyether ether ketone (PEEK), polyether ketone (PEK), poly(p-phenylene sulfide) (PPS/Ryton®), and polyurethane.

29. A method of manufacturing the composition according to claim 27, wherein said composition comprises one or more polymers selected from the group consisting of polyethylene naphthalate (PEN), polyethylene terephthalate (PET), polybutylene naphthalate (PBN), polytrimethylene naphthalate (PTN), poly(cyclohexylene dimethylene terephthalate) acid (PCTA), and polybutylene terephthalate (PBT).

30. A method of manufacturing the composition according to claim 27, wherein said composition comprises one or more additives selected from the group consisting of: stabilizers, compatibilizers, hydrolysis or oxidation-resistant additives, dyes, pigments, and fumed silica.

31. A method of manufacturing the composition according to claim 27, wherein said composition is extruded into fiber, yarn, rings, films, foil, mesh, netting, or other extruded elements, a structured deposit in a desired pattern, or a coating.

32. A method of manufacturing the composition according to claim 31, wherein said extruded fiber has a size between about 1.1 dtex to about 200 dtex.

33. A method of manufacturing the composition according to claim 31, wherein said extruded yarn has a diameter between about 0.08 mm to about 5 mm.

34. The composition according to claim 1, wherein said composition is used to manufacture a component of an industrial fabric, wherein said component is a yarn, fiber, film, foil, tape, netting (mesh), rings or other extruded elements, a structured deposit in a desired pattern, or a coating.

35. The industrial fabric of claim 34, comprising a fabric selected from the group consisting of PMC forming, press, and dryer fabrics, as well as process belts, impression fabrics; TAD fabrics; fabrics for eTAD, ATMOS, or NTT machines; engineered fabrics, sleeves or belts used in the production of nonwoven fabrics by processes such as air laid, melt blowing, spunbonding or hydroentangling; fabrics used in a sludge filter or other wet filtration process; conveyor belts for industrial uses such as food processing or mining; corrugator belts; spiral coil links for spiral link belts, their pintles or any stuffer yarns; fabrics or belts used in textile finishing processes; belts or fabrics used to produce building products; or tannery belts or sleeves.

36. The industrial fabric of claim 35, wherein said fabric is woven from yarns in the MD and/or CD, or is a nonwoven fabric layer of MD or CD yarn arrays, spiral links, mesh or netting, rings, foils, films or other extruded elements, a structured deposit in a desired pattern, or a coating.

37. A mesh or netting, fiber, yarn, rings, films, foil, or other extruded elements, a structured deposit in a desired pattern, or a coating, comprising a resin component of claim 1.

38. A paper machine clothing, comprising a resin component of claim 1.

39. An industrial fabric, belt, or sleeve comprising a resin component of claim 1.

40. The composition of claim 1, which is used to produce fiber, wherein said fiber is used in the bait portion of industrial fabric.

41. The paper machine clothing of claim 38, wherein the paper machine clothing is selected from the group consisting of: a reel belt, a TAD, an eTAD, an ATMOS, and an NTT fabric.

42. An engineered fabric comprising a DNT belt, a belt for a filter press, pulp washer, belt to produce building products such as oriented strand board or a corrugators belt, a tannery sleeve, or a textile finishing belt, comprising a component of claim 1.

43. The fabric of claim 38 or 42, wherein the component is a batt portion of a press fabric or a corrugator belt.

44. The engineered fabric of claim 42, wherein the fabric, sleeve, or belt is used to produce nonwovens by a process selected from the group consisting of: air laid, spun bond, melt spun, or hydroentangling.

45. A stuffer yarn or pintle comprising a component of claim 1.
